(19) United States
(12) Patent Application Publication
(10) Pub. No.: US 2015/0271153 A1
(43) Pub. Date: Sep. 24, 2015

(54) INFORMATION MANAGEMENT USING PROXY RE-ENCRYPTION

(71) Applicants: Kurt Ryan Rohloff, South Hadley, MA (US); Mathew James Gillen, Maynard, MA (US); Joseph Patrick Loyall, Acton, MA (US)

(72) Inventors: Kurt Ryan Rohloff, South Hadley, MA (US); Mathew James Gillen, Maynard, MA (US); Joseph Patrick Loyall, Acton, MA (US)

(21) Appl. No.: 13/545,837

(22) Filed: Jul. 10, 2012

(51) Int. Cl. H04L 29/06; H04L 9/08

(52) U.S. Cl. CPC H04L 63/0464; H04L 63/0471; H04L 9/0861

(57) ABSTRACT

A system for securely transmitting information from a plurality of data sources to a plurality of data consumers, each of the data consumers being associated with a corresponding set of one or more subscriber tags includes a computer system configured to: receive a message from a data source of the data sources, the message including encrypted data and one or more metadata tags describing the encrypted data; identify one or more recipient data consumers of the data consumers in accordance with whether the metadata tags and the sets of tags associated with the data consumers satisfy one or more rules; and for each identified recipient data consumer of the identified recipient data consumers: re-encrypt the encrypted data of the message using a re-encryption key corresponding to the data source and the identified data consumer to generate re-encrypted data; and transmit the re-encrypted data to the identified recipient data consumer.

### BACKGROUND

1. Field

Embodiments of the present invention relate to systems and methods for securely transmitting data from multiple data sources to multiple data consumers.

2. Background

Modern U.S. military operations often involve joint and multi-national operations, increasingly requiring the exchange of information with partners that cross service and coalition boundaries. Information brokering platforms using publish-subscribe (“pub-sub”) dissemination have emerged to handle the scale, beyond line-of-sight (BLOS) visibility, and the discovery of information and services needed for these dynamic tactical operations. However, the current state of the art in pub-sub based dissemination of information generally requires either 1) the cumbersome and expensive dedication of trusted resources to securely host encryption keys and encryption/decryption operations at the brokering service for every piece of information sent to different partners; or 2) the transmission of sensitive data on wireless channels in unencrypted form (which is generally unacceptable).

Up until now, there has been no publish-subscribe mechanism for secure data sharing. Pub-sub mechanisms have been well known, but these approaches generally could not securely “push” information for the consumption of intended subscribers unless the data was either 1) originally encrypted in a form that could be directly decrypted by the consumers or 2) was decrypted and encrypted again at the publish-subscribe mechanism (or “brokering service”). In addition, many systems implementing pub-sub mechanisms such as the Data Distribution Service (DDS) standard and the Oracle® Java Message Service (JMS) are simply dissemination/communication abstractions and generally are not used for active brokering on messages. These systems generally do not include encryption as part of the infrastructure.

In the field of data encryption, the term proxy re-encryption (PRE) is used to describe a category of protocols in which messages can be securely transmitted from a first party to a second party via an intermediary. For example, a first party may encrypt a cleartext message into ciphertext which is reencrypted by the intermediary to be directly decrypted by the second party using the second party's secret key. During this process, the intermediary does not have access to the cleartext or the secret key. See, e.g., “Divertible Protocols and Atomic Proxy Cryptography.” M. Blaze, G. Bleumer, M. Strauss. Proceedings of EUROCRYPT '98, International Conference on the Theory and Application of Cryptographic Techniques, Espoo, Finland, May 31-Jun. 4, 1998, Lecture Notes in Computer Science 1403 Springer 1998, 127-144 and “Improved Proxy Re-encryption Schemes with Applications to Secure Distributed Storage”. G. Ateniese, K. Fu, M. Green, S. Hohenberger. ACM Transactions on Information and System Security (TISSEC), Volume 9, Issue 1, 2006.

### SUMMARY

Embodiments of the present invention provide systems and methods for the secure sharing of information generated by a large number of sources and shared with a large number of consumers through the use of a pub-sub information distribution system in conjunction with proxy re-encryption.

According to aspects of the present invention, a data source may encrypt sensitive data and transmit the encrypted data to the pub-sub information distribution system. The pub-sub system may then identify appropriate consumers of the data (e.g., based on metadata associated with the message and “subscription” information associated with the consumers) and re-encrypt a copy of the encrypted message for each identified consumer. By using proxy re-encryption, the encrypted data may be re-encrypted for into data that would be decryptable only by the recipient consumer and may be accomplished without first decrypting the data received from the source. As such, embodiments of the present invention provide a secure system for sharing information between large numbers of sources and consumers.

For example, embodiments of the present invention may be used in the defense domain to securely share sensitive information between coalition partners; in the healthcare information technology domain for groups of doctors to securely share patient medical records; and in the entertainment domain to securely share archived media (e.g., text, audio, and video) with authorized (e.g., paid) subscribers.

According to one embodiment of the present invention, a method for securely transmitting information, via an intermediary, from a plurality of data sources to a plurality of data consumers, each of the data consumers being associated with a corresponding set of one or more tags includes: receiving a message from a data source of the data sources, the message including encrypted data and one or more metadata tags describing the encrypted data; identifying one or more recipient data consumers of the data consumers in accordance with whether the metadata tags and the sets of tags associated with the data consumers satisfy one or more rules; and for each identified recipient data consumer of the identified recipient data consumers: re-encrypting the encrypted data of the message using a re-encryption key corresponding to the data source and the identified data consumer to generate re-encrypted data; and transmitting the re-encrypted data to the identified recipient data consumer.

The metadata tags may include a geographical coordinate.

The metadata tags may include a security classification level.

In some embodiments, the re-encrypting the encrypted data of the message does not include comprise decrypting the encrypted data.

The intermediary may be a pub-sub server.

The method may further include: receiving encryption keys generated by the data sources and the data consumers; and generating a plurality of re-encryption keys using the received encryption keys, the re-encryption keys comprising the re-encryption keys corresponding to the data source and the identified data consumers.

The generating the plurality of re-encryption keys may be performed by a re-encryption key generating server, the re-encryption key generating server being different from the intermediary.

The transmitting the re-encrypted data to the identified recipient data consumer may include broadcasting the re-encrypted data to a plurality of data consumers.

According to another embodiment of the present invention, a system for securely transmitting information from a plurality of data sources to a plurality of data consumers, each of the data consumers being associated with a corresponding set of one or more subscriber tags includes a computer system configured to: receive a message from a data source of the data sources, the message including encrypted data and one or more metadata tags describing the encrypted data; identify one or more recipient data consumers of the data consumers in accordance with whether the metadata tags and the sets of tags associated with the data consumers satisfy one or more rules; and for each identified recipient data consumer of the identified recipient data consumers: re-encrypt the encrypted data of the message using a re-encryption key corresponding to the data source and the identified data consumer to generate re-encrypted data; and transmit the re-encrypted data to the identified recipient data consumer.

The computer system may be configured to re-encrypt the encrypted data without decrypting the encrypted data.

The computer system may be a pub-sub server.

The system may further include a key generating server configured to: receive encryption keys generated by the data sources and the data consumers; and generate a plurality of re-encryption keys using the received encryption keys, the re-encryption keys including the re-encryption keys corresponding to the data source and the identified recipient data consumers.

The key generating server may be separate from the computer system.

The computer system may be configured to transmit the re-encrypted data to a plurality of data consumers.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic diagram illustrating one embodiment of the present invention in a military environment.

FIG. 2 is a schematic diagram illustrating one embodiment of the present invention in a medical environment.

FIG. 3 is a schematic block diagram illustrating a secure information management system including an intermediary pub-sub instance according to one embodiment of the present invention.

FIG. 4A is a flowchart illustrating a setup phase of a method securely transmitting data from a data source to a plurality of data consumers according to one embodiment of the present invention.

FIG. 4B is a flowchart illustrating a setup phase of a method securely transmitting data from a data source to a plurality of data consumers according to another embodiment of the present invention.

FIGS. 5A and 5B are flowcharts illustrating an online phase of a method securely transmitting data from a data source to a plurality of data consumers according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

According to one embodiment of the present invention, a number of consumers may be registered with a pub-sub system to receive messages relating to a plurality of topics. The pub-sub system may receive encrypted messages from the data sources, the encrypted messages including unencrypted metadata. For each encrypted message, the pub-sub system may identify a subset of the consumers who should receive that encrypted message, in accordance with the metadata and the consumers subscribed topics. For each consumer in the identified subset, the pub-sub system re-encrypts the message for direct decryption by the recipient consumer. The re-encryption of the message occurs without first decrypting the message through the use of a re-encryption key, where the re-encryption key is generated on a per-source-consumer pair basis in accordance with the source's encryption key and the consumer's decryption key.

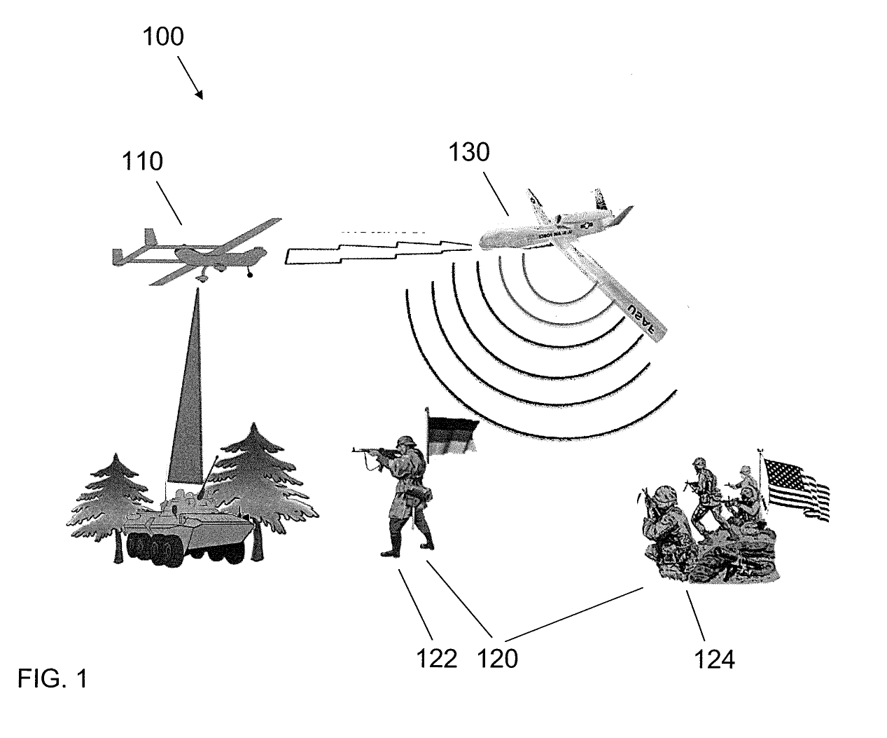

FIG. 1 is a schematic diagram illustrating the communication of information within a military environment according to an embodiment of the present invention. In the military example shown in FIG. 1, data sources 110 (e.g., an unmanned aerial vehicle or UAV) collect sensitive data that is to be transmitted to data consumers 120 (e.g., troops on the ground). Because data sources 110 and data consumers 120 may frequently be added and removed throughout the lifetime of the communication system, the sensitive data may be routed through an intermediary 130 to be retransmitted to the data consumers 120 in order to manage the complexity of the communication system.

For example, publish-subscribe (“pub-sub”) information dissemination systems can be used as the intermediary 130 to simplify the routing of messages. In a pub-sub system, each of the data consumers 130 is associated with its own set of tags (or topics), which is registered with the intermediary 130. Data sources 110 publish messages, along with metadata tags describing the content of the message, to an intermediary (or message broker).

When a message is published to the intermediary 130, the intermediary 130 identifies a set of data consumers 120 that, based on a set of rules, match the tags associated with the message and delivers the message to those identified data consumers. In other words, each of the data consumers “subscribes” to a set of topics (or tags) to receive messages related to those topics. When the intermediary 130 receives new messages with associated metadata tags, the intermediary identifies which topics match the metadata tags and delivers the message to consumers subscribed to the matching topics.

For example, in one embodiment of a pub-sub system, if data consumer Alpha was associated with tags “A” and “C” and data consumer Beta was associated with tags “B” and “C”, a message tagged with tag “A” would be delivered to Alpha and not Beta, a message tagged with “B” would be delivered to Beta and not Alpha, and a message tagged with “C” would be delivered to both Alpha and Beta.

As another example, in one embodiment of a pub-sub system, messages may be processed based on one or more rules. For example, a message may be tagged with a particular security classification level and the pub-sub system would deliver the message only to data consumers 120 associated with security clearance levels equal to or higher than the security classification level on the tag.

In many environments, due to the sensitive nature of the data collected, the data sources 110 generally encrypt the data before transmission. As such, the data consumers 120 must possess the proper decryption keys to decrypt the sensitive data received from the data sources 110.

Previous publish-subscribe systems generally require either 1) encryption of data by the source of the data in a form that can be directly decrypted by the consumer or 2) decryption of sensitive information at the publish-subscribe instance before it is encrypted again and shared. The direct encryption by sources of data for specific consumers is difficult to scale to large numbers of sources or consumers. The decryption of data at the publish-subscribe instance reduces the security of the system (e.g., if the publish-subscribe instance were to be compromised).

Aspects of embodiments of the present invention provide systems and methods for 1) securely performing publish-subscribe operations, 2) without requiring the data sources to know beforehand who the consumers of the data will be, and 3) without requiring the full decryption of any data before it reaches the intended consumer.

Embodiments of the present invention do not require full decryption of the messages at the publish-subscribe instance and do not require publishers of data to know who the consumers of that data will be. As such, embodiments of the present invention provide a more secure publish-subscribe capability that is also scalable to large numbers of producers and consumers of data. Embodiments of the present invention can route data to users that are not fully trusted, such as in joint, multi-national, and coalition operations without decrypting the message during the transit process. Prior publish-subscribe systems required the decryption of sensitive data in order to broker that data for consumption by specific users. In contrast, embodiments of the present invention provide secure, on-the-fly data dissemination, even in wireless broadcast environments, despite potentially not knowing which data consumers should have access to the data when the data is first encrypted.

Embodiments of the present invention also enable secure data dissemination on less-trusted hardware in hostile environments. For example, even if the hardware hosting a running pub-sub instance according to embodiments of the present invention were to be fully compromised, this compromised host would not be able to decrypt the data and, at worst, would be able to transmit sensitive data to coalition partners that have been approved to receive at least some sensitive data.

Embodiments of the present invention are computationally efficient and are deployable with commodity military information management hardware and software, thereby making the system inexpensive to use and reducing or eliminating the need for special security-enabled hardware and software that could be compromised by use in the field.

Embodiments of the present invention provide a secure pub-sub information dissemination platform. Producers of information (data sources) locally encrypt information with their personal key. This information is sent to an intermediary pub-sub instance according to an embodiment of the present invention. The intermediary pub-sub instance securely switches the key under which sensitive data is encrypted, without full decryption of the encrypted message and without allowing sensitive data to be accessed by unapproved data consumers. This key-switching by the intermediary pub-sub instance according to embodiments of the present invention enables consumers of information to securely receive only the data which they are intended to receive. The encrypted information can then be broadcast for data consumers. The only data consumers that can decrypt the data are the data consumers who hold the private keys which can decrypt the data. (For example, this key-switching by the intermediary pub-sub instance 130 enables coalition partners in a military environment to securely receive only the data which they are intended to receive.)

According to one embodiment of the present invention, a proxy re-encryption system is used in combination with a pub-sub information dissemination system to provide systems and methods for securely managing the transfer of information between a plurality of data sources and a plurality of data consumers.

Still referring to FIG. 1, according to one embodiment of the present invention, the data sources 110 encrypt the sensitive data using their public keys (e.g., a public key associated with that data source). The data sources 110 (e.g., unmanned aerial vehicles or UAVs) send the encrypted messages along with metadata tags to an intermediary publish-subscribe instance 130. The intermediary pub-sub instance 130 performs a re-encryption operation on the received data with respect to the intended consumers 120 of that data and then broadcasts the re-encrypted data to the data consumers. Only the intended consumers of the re-encrypted data are able to decrypt the data.

For example, a UAV serving as the data source 110 may collect aerial images of troop movements. The UAV may then encrypt the data using its public key and tag the data with the geographic location associated with that data (e.g., a longitude and latitude) and send the encrypted data, along with the tag, to an intermediary pub-sub instance 130. When received, the message may be processed using a rule that re-encrypts the message for consumption by data consumers 120 who are currently within a 5-mile radius of the location of the aerial image data. In this example, the German infantry 122 is within the 5-mile radius, but the American infantry 124 is not. As such, one copy of the data is re-encrypted for decryption by the German infantry 122 but a copy is not re-encrypted for decryption by the American infantry 124. The re-encrypted data may be broadcast to both intended and unintended consumers, e.g., both German 122 and American 124 infantry in this case. However, only the intended consumer (e.g., the German infantry 122) can decrypt the re-encrypted messages intended for it.

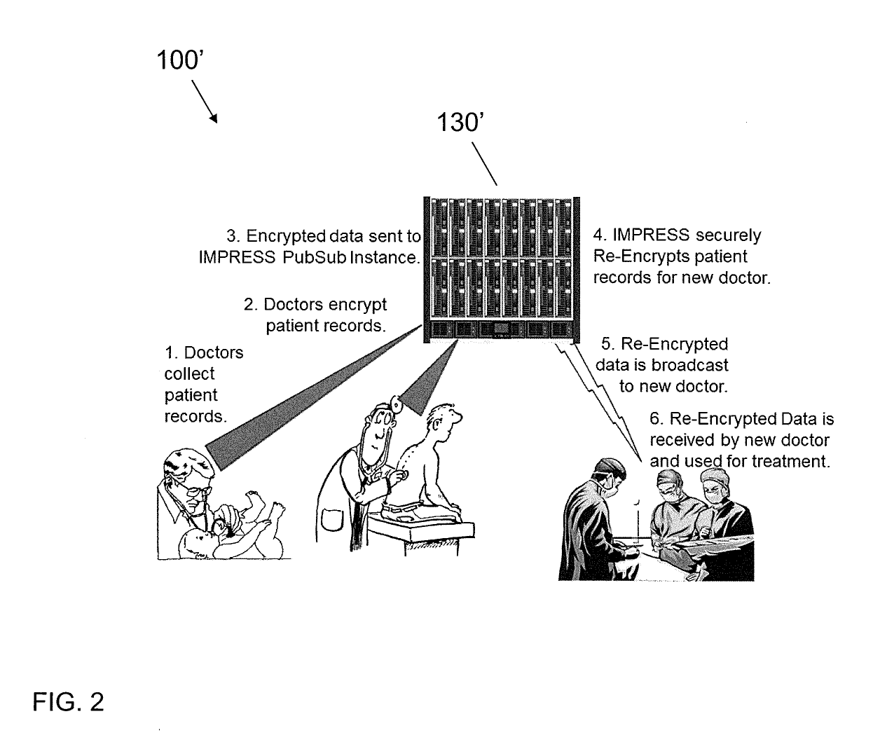

FIG. 2 is a schematic diagram illustrating another embodiment of the present invention in a healthcare setting. Referring to FIG. 2, according to one embodiment of the present invention, primary care doctors of patients collect information about their patients over the course of multiple treatments. As the primary care doctors collect this information, they encrypt the information on each patient interaction and send it to an intermediary publish-subscribe instance 130′ for storage.

In this embodiment of the present invention, the metadata includes a patient identifier (e.g., the patient's social security number) and possibly some additional metadata such as tagging some information as relating to patient allergies and other information as relating to patient psychological treatment.

When a patient visits an emergency care doctor (e.g., during an emergency room visit), the emergency care doctor should only have access to a subset of the patient's records from the intermediary pub-sub instance 130′ that would be relevant to the scope of care. For instance, the emergency room doctor might need information about patient allergies to latex and penicillin, but may not need information about less severe psychological treatments. According to one embodiment, the intermediary pub-sub instance 130′ would re-encrypt all records corresponding to the patient that the emergency care doctor should have access to so that the information can be decrypted by the emergency care doctor.

The rules for selecting what types of information the emergency care doctors have access to may be pre-selected by the patient (ostensibly with guidance from the primary care doctors) and maintained by the intermediary pub-sub instance 130′. The primary care doctors can encrypt the patient files with the patient's public keys. The intermediary pub-sub instance 130′ would then send these select re-encrypted records to the emergency care doctor so that the emergency care doctor could then decrypt and use the information to assist in treating the patient.

According to another embodiment of the present invention, data sources may be sources of content (e.g., a subscription to a paid internet audio service) and the data consumers may include subscribers to the content. Different portions of the content may be available to users based on the subscription and interests of the users. For example, in the paid internet audio service, one user may subscribe only to live streaming of sporting events while another user may subscribe only to live streaming of general interest talk radio. As such, the two users would have a different set of tags associated with them, identifying the type of content that they have subscribed to (e.g., “sports” and “talk”). The intermediary pub-sub instance receives content from the data sources, such as a first stream containing the play-by-play commentary from a basketball game (tagged “sports”) and a second stream containing the live feed from a talk show studio (tagged “talk”). The intermediary pub-sub instance then detects that the first stream is tagged “sports” and that the first user is subscribed to “sports” and, as such, re-encrypts the first stream for consumption by the first data consumer. Similarly, the intermediary pub-sub instance detects that the second stream is tagged “talk” and re-encrypts the second stream for consumption by the second user. The second user cannot access the first stream because the intermediary pub-sub instance re-encrypts copies of the stream only for subscribing data consumers (using their respective re-encryption keys).

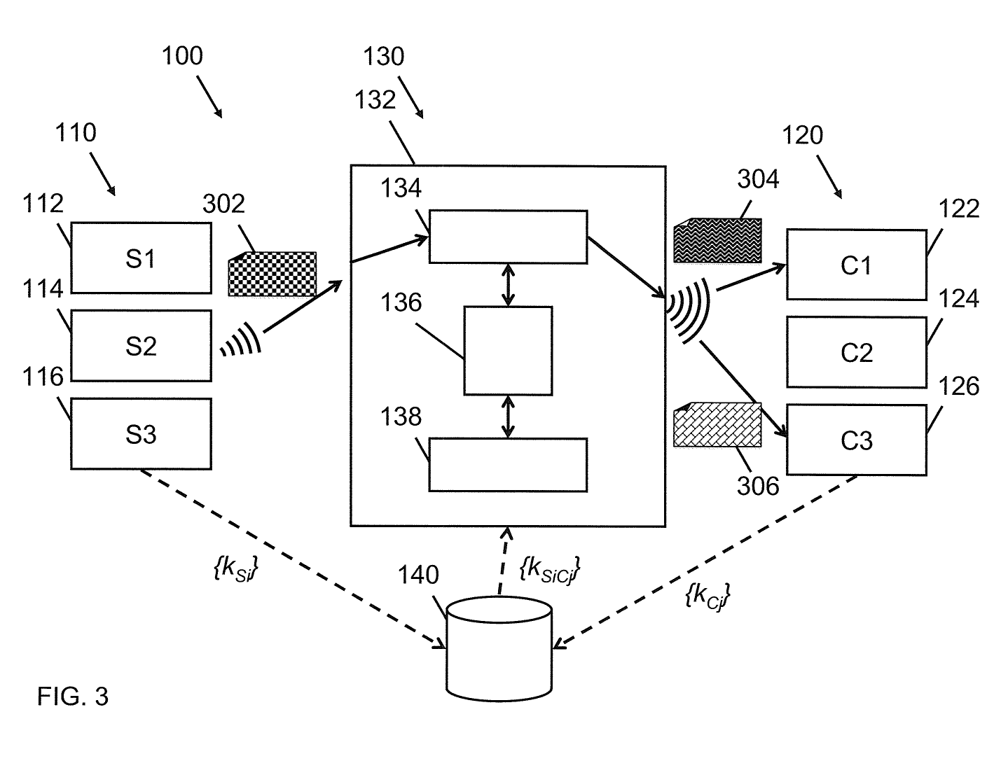

FIG. 3 is a schematic block diagram illustrating a secure information management system including an intermediary pub-sub instance according to one embodiment of the present invention. Referring to FIG. 3, a secure information management system 100 includes an intermediary pub-sub instance 130 configured to receive messages published by data sources 110, re-encrypt the messages, and transmit the re-encrypted messages to subscribing data consumers 120.

According to one embodiment of the present invention, the intermediary pub-sub instance 130 includes a computer system 132 including a communications device 134 (e.g., a network interface device coupled to a wireless data transmission system), a memory 138, and a processor 136 coupled to the communications device and the memory. The communications device 134 may be configured to receive messages from the data sources 110 and transmit messages to data consumers 120 using a data connection (e.g., a TCP/IP connection). The memory 138 may be configured to store messages during processing, and to store a plurality of re-encryption keys for re-encrypting messages received from the data sources 110 to be decrypted by one or more data consumers. The memory 138 may also be configured to store mappings between the plurality of data consumers 120 and sets of tags, each of the data consumers being associated with an individual set of tags. Furthermore, the memory 138 may be configured to store a plurality of rules for determining whether or not a message should be re-encrypted for a particular data consumer, in accordance with the one or more metadata tags associated with the message and the set of tags associated with the particular data consumer. The processor 136 may be configured to re-encrypt messages using the stored re-encryption keys in accordance with the stored rules.

In some embodiments, the intermediary pub-sub instance 130 further comprises a configuration interface (not shown) for configuring the plurality of rules.

For example, in the embodiment shown in FIG. 3, a data source 114 sends an encrypted message 302 to the intermediary pub-sub instance 130. The intermediary pub-sub instance 130 reads the tags associated with the message 302 and re-encrypts the message 302 for identified recipient data consumers from among the data consumers 120. In this example, data consumers 122 and 126 are identified as recipients in accordance with the metadata tags associated with the message 302 and the tags associated with the data consumers. As such, the intermediary pub-sub instance 130 re-encrypts message 302 to produce re-encrypted messages 304 and 306 which are broadcast to all data consumers (within the network) and which are respectively decryptable only by data consumers 122 and 126.

According to one embodiment of the present invention, the intermediary pub-sub instance 130 re-encrypts messages received from a data source into a form decryptable by a data consumer, without decrypting the data, by using a proxy re-encryption (PRE) protocol as described, for example, in “Improved Proxy Re-encryption Schemes with Applications to Secure Distributed Storage”. G. Ateniese, K. Fu, M. Green, S. Hohenberger. ACM Transactions on Information and System Security (TISSEC), Volume 9, Issue 1, 2006. However, embodiments of the present invention are not limited to the specific PRE protocols described in the above reference and may be used with other encryption protocols that allow the re-encryption of data encrypted by a first party such that the re-encrypted data can be decrypted only by a second party.

In one example, a data source A may send an encrypted message to recipient B, where the encrypted message is only decryptable by recipient B (e.g., encrypting a message using public key cryptography). However, with the use of a proxy re-encryption system, B can delegate decryption of the message to a third party (C) by using a re-encryption key generated by a proxy re-encryption protocol using both B's decryption key and an encryption key associated with C. Applying the re-encryption key to the original encrypted message received from A transforms the message from one that is decryptable only by B to a message that is only decryptable by C, without passing through an intermediate stage of decryption.

According to one embodiment of the present invention, a method of providing secure transmission of data in a pub-sub system includes a setup phase and an online phase of operation.

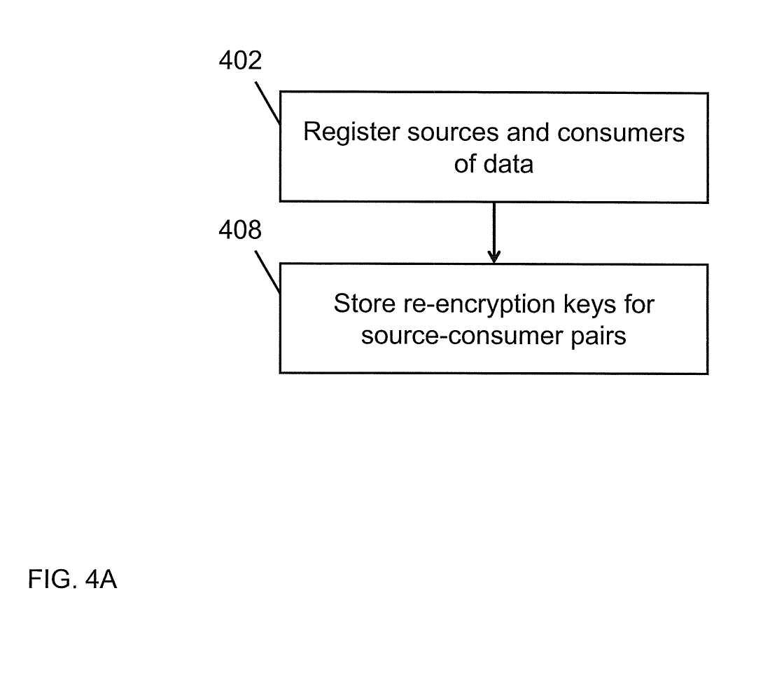

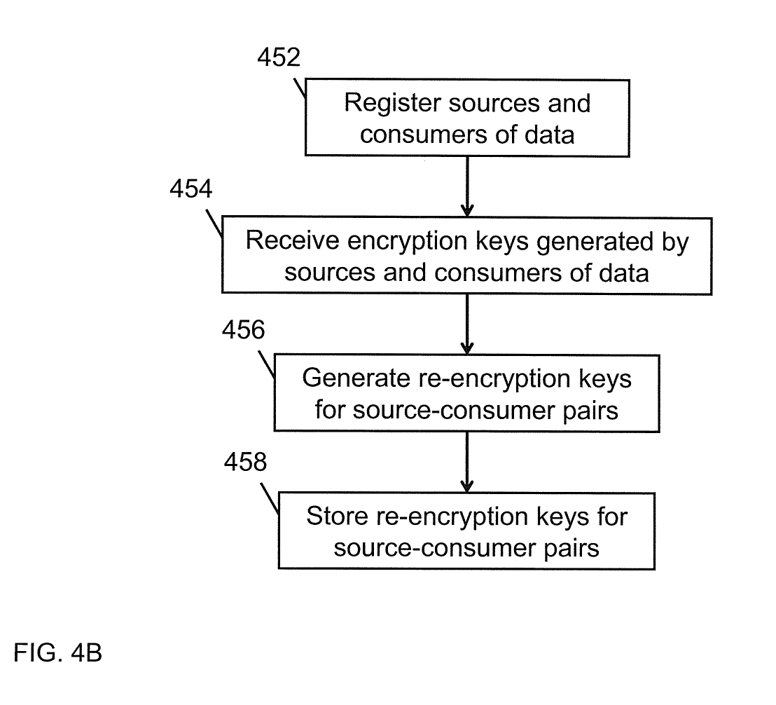

FIG. 4A is a flowchart illustrating a setup phase of a method of securely transmitting data from a data source to a plurality of data consumers according to one embodiment of the present invention.

Referring to FIG. 4A, an intermediary pub-sub instance 130 according to one embodiment of the present invention may be configured to register sources and consumers of data 402 and store re-encryption keys for the source-consumer pairs 408. Registering sources and consumers of data 402 may include storing a set of tags for each of the data consumers. In some embodiments of the present invention, additional identifying information (e.g., a certificate, an IP address, or a unique ID) may be used as a signature.

Storing 408 a unique re-encryption key for each of the source-consumer pairs that communicate with one another through the intermediary pub-sub instance 130 may include generating or receiving a plurality of re-encryption keys, one re-encryption key for each pairing. The re-encryption keys may be generated by and received from a trusted third party (e.g., a server configured to generate re-encryption keys, see 140 in FIG. 3). The trusted third party may be a computing device physically distinct from the intermediary pub-sub instance 130. For example, if data sources S1, S2, and S3 are expected to communicate with three data consumers C1, C2, and C3 via the intermediary pub-sub instance 130, the intermediary pub-sub instance 130 would store nine re-encryption keys: {k_{S1,C1}, k_{S1,C2, k}_{S1,C3}, k_{S2,C1}, . . . , k_{S3,C3}}.

Referring to FIG. 3, the data sources S1, S2, and S3 would send encryption keys k_{S1}, k_{S2}, and k_{S3} (collectively referred to as {k_{Si}} in FIG. 3) to the re-encryption key generation server 140. Similarly, the data consumers C1, C2, and C3 would send encryption keys k_{C1}, k_{C2}, and k_{C3} (collectively referred to as {k_{Ci}} in FIG. 3) to the re-encryption key generation server 140. The re-encryption key generation server 140 would then generate the re-encryption keys {k_{S1,C1}, k_{S1,C2}, k_{S1,C3}, k_{S2,C1}, . . . , k_{S3,C3}} (collectively referred to as {k_{Si,Ci}} in FIG. 3) and send the re-encryption keys to the intermediary pub-sub instance 130.

FIG. 4B is a flowchart illustrating a setup phase of a method of securely transmitting data from a data source to a plurality of data consumers according to another embodiment of the present invention. Referring to FIG. 4B, according to one embodiment, the setup phase includes:

1. Registering sources and consumers of data (452) in a manner substantially similar to that described above with respect to operation 402 in FIG. 4A.

2. Data sources agree upon a common set of public encryption keys that they will use to encrypt data that will be sent to the intermediary pub-sub instance 130. Similarly, consumers of the data select (454) private encryption keys that they will use to decrypt data sent to them. These keys may also be generated using the PRE protocol. The sources and consumers then send their generated keys to trusted third parties (454).

3. The third parties generate (456) the re-encryption keys for all possible source-consumer pairs where data would need to be sent from a particular source to a particular consumer (e.g., as described above with respect to FIG. 4A and operation 408). The generation of the re-encryption keys may also be accomplished in accordance with the PRE protocol.

4. The trusted third parties then send the re-encryption keys to the intermediary pub-sub instance, which stores (458) the re-encryption keys locally.

In some embodiments, re-encryption keys may be generated by the intermediary pub-sub instance 130 instead of by a third party.

In addition, in some embodiments, the setup phase may further include configuring and storing one or more rules for determining which of the data consumers should receive a given message.

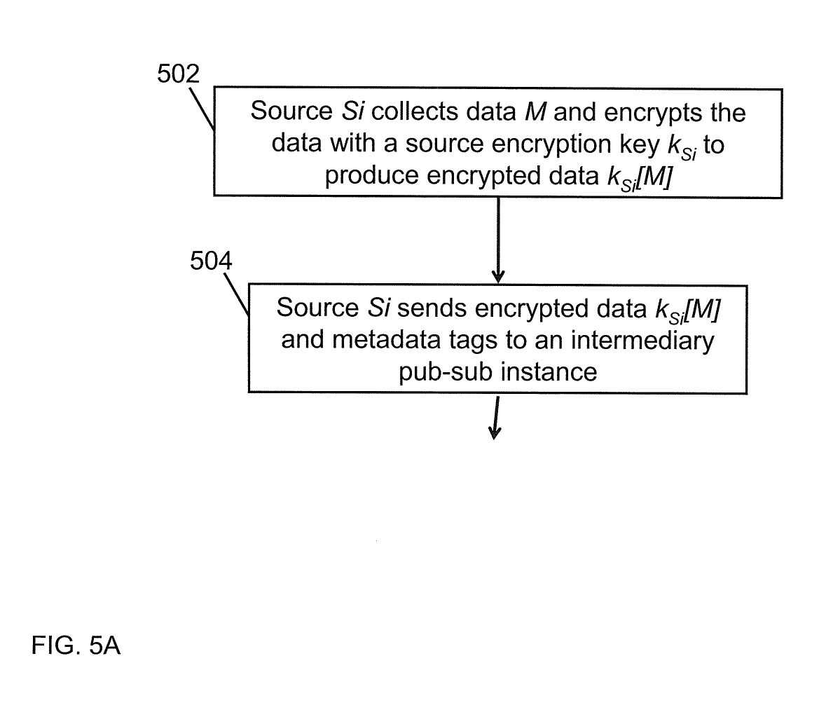

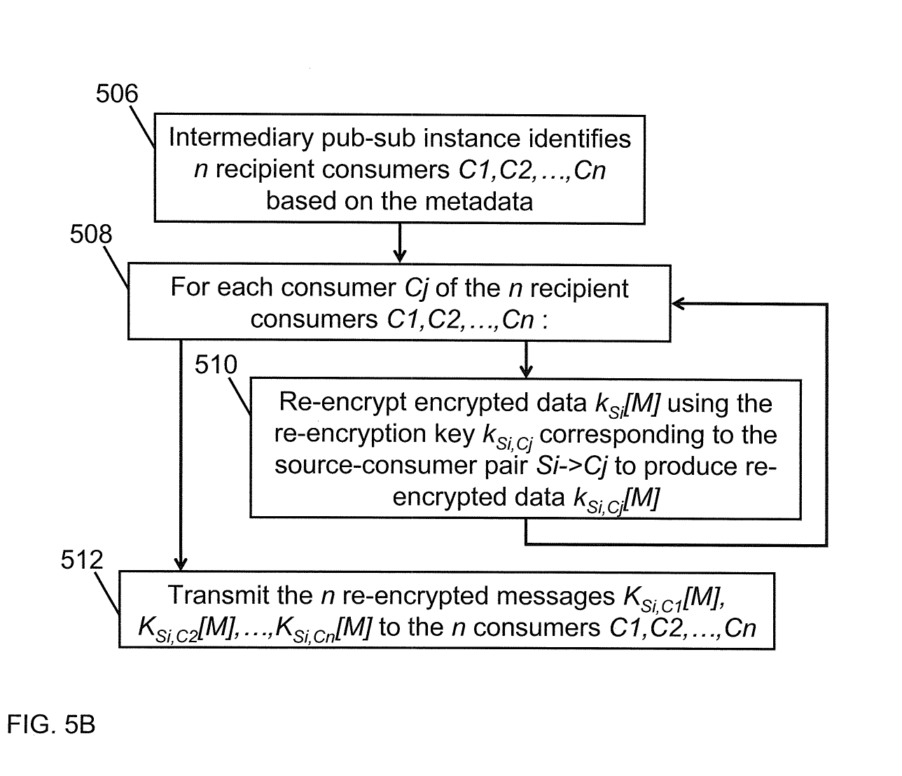

FIGS. 5A and 5B are flowcharts illustrating an online phase of a method for securely transmitting data from a data source to a plurality of data consumers according to one embodiment of the present invention. Referring to FIG. 5A, the online phase includes:

A data source Si collects sensitive data that is of value to consumers (502) and encrypts collections of sensitive data (or messages) M with the source's public key k_{Si} as the data is collected.

The collections of encrypted data k_{Si}[M] (denoting a message M encrypted by key k_{Si}) are sent by the sources to the intermediary pub-sub instance 130 along with unencrypted metadata tags that describe the contents of the encrypted data (504).

Referring to FIG. 5B, when the intermediary pub-sub instance 130 receives encrypted data with associated metadata, the intermediary pub-sub instance 130 identifies particular consumers (C1, C2, . . . , Cn) whose needs (e.g., whose sets of tags) match with the associated metadata in accordance with a plurality of rules stored in the intermediary pub-sub instance 506. Then, for each consumer Cj in the set of n identified consumers C1, C2, . . . , Cn, the intermediary pub-sub instance 130 identifies the re-encryption key k_{Si,Cj} for each source-consumer pair Si−>Cj (denoting a re-encryption key for re-encrypting a message originally encrypted by source Si such that it can be decrypted by consumer Cj) corresponding to the data source associated with the message (Si) and the consumer Cj and re-encrypts the received encrypted data k_{Si}[M] to produce a re-encrypted message k_{Si,Cj}[M], (in other words, a set of re-encrypted messages, one for each of the consumers, the re-encrypted messages being k_{S1,C1}[M], k_{Si,C2}[M], . . . , k_{Si,Cn}[M]) (508 and 510). The resulting re-encrypted messages can be decrypted only by the corresponding consumers.

The re-encrypted data is broadcast (512) by the intermediary pub-sub instance 130 and received by the intended consumer (and possibly other unintended consumers). Only the intended consumer can decrypt the re-encrypted message because it alone (other than the trusted 3rd party) has a secret key that can decrypt the re-encrypted message.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for securely transmitting information, via an intermediary, from a plurality of data sources to a plurality of data consumers, each of the data consumers being associated with a corresponding set of one or more tags, the method comprising:
receiving a message from a data source of the data sources, the message comprising encrypted data and one or more metadata tags describing the encrypted data;
identifying one or more recipient data consumers of the data consumers in accordance with whether the metadata tags and the sets of tags associated with the data consumers satisfy one or more rules; and
for each identified recipient data consumer of the identified recipient data consumers:
re-encrypting the encrypted data of the message using a re-encryption key corresponding to the data source and the identified data consumer to generate re-encrypted data; and
transmitting the re-encrypted data to the identified recipient data consumer.

2. The method of claim 1, wherein the metadata tags comprise a geographical coordinate.

3. The method of claim 1, wherein the metadata tags comprise a security classification level.

4. The method of claim 1, wherein the re-encrypting the encrypted data of the message does not comprise decrypting the encrypted data.

5. The method of claim 1, wherein the intermediary is a pub-sub server.

6. The method of claim 1, further comprising:
receiving encryption keys generated by the data sources and the data consumers; and
generating a plurality of re-encryption keys using the received encryption keys, the re-encryption keys comprising the re-encryption keys corresponding to the data source and the identified data consumers.

7. The method of claim 6, wherein the generating the plurality of re-encryption keys is performed by a re-encryption key generating server, the re-encryption key generating server being different from the intermediary.

8. The method of claim 1, wherein the transmitting the re-encrypted data to the identified recipient data consumer comprises broadcasting the re-encrypted data to a plurality of data consumers.

9. A system for securely transmitting information from a plurality of data sources to a plurality of data consumers, each of the data consumers being associated with a corresponding set of one or more subscriber tags, the system comprising a computer system configured to:
receive a message from a data source of the data sources, the message comprising encrypted data and one or more metadata tags describing the encrypted data;
identify one or more recipient data consumers of the data consumers in accordance with whether the metadata tags and the sets of tags associated with the data consumers satisfy one or more rules; and
for each identified recipient data consumer of the identified recipient data consumers:
re-encrypt the encrypted data of the message using a re-encryption key corresponding to the data source and the identified data consumer to generate re-encrypted data; and
transmit the re-encrypted data to the identified recipient data consumer.

10. The system of claim 9, wherein the metadata tags comprise a geographical coordinate.

11. The system of claim 9, wherein the metadata tags comprise a security classification level.

12. The system of claim 9, wherein the computer system is configured to re-encrypt the encrypted data without decrypting the encrypted data.

13. The system of claim 9, wherein the computer system is a pub-sub server.

14. The system of claim 9, further comprising a key generating server configured to:
receive encryption keys generated by the data sources and the data consumers; and
generate a plurality of re-encryption keys using the received encryption keys, the re-encryption keys comprising the re-encryption keys corresponding to the data source and the identified recipient data consumers.

15. The system of claim 14, wherein the key generating server is separate from the computer system.

16. The system of claim 9, wherein the computer system is configured to transmit the re-encrypted data to a plurality of data consumers.
